(19) United States
(12) Patent Application Publication
(10) Pub. No.: US 2018/0307405 A1
(43) Pub. Date: Oct. 25, 2018

(54) CONTEXTUAL VEHICLE USER INTERFACE

(71) Applicant: Ford Global Technologies, LLC, Dearborn, MI (US)

(72) Inventor: Heramb Dandekar, Farmington Hills, MI (US)

(21) Appl. No.: 15/494,041

(22) Filed: Apr. 21, 2017

(51) Int. Cl. G06F 3/0488; G06F 3/033; G06F 3/01; B60K 35/00

(52) U.S. Cl. CPC G06F 3/04883; G06F 3/033; G06F 3/017; B60K 35/00; B60K 2350/1068; G06F 2203/04808; B60K 2350/1048; B60K 2350/1052; B60K 2350/352; G06F 2203/04806

(57) ABSTRACT

Method and apparatus are disclosed for a vehicle user interface. The vehicle user interface includes a display for a plurality of menus. The vehicle user interface also includes a steering wheel having a joystick, and a gesture pad having a plurality of available input gestures. The vehicle user interface also includes a processor for modifying the display responsive to input from the steering wheel joystick and gesture pad, wherein at least one input gesture is available for all displayed menus, and availability of at least one input gesture changes based on the menu displayed.

### TECHNICAL FIELD

The present disclosure generally relates to control of one or more systems of a vehicle via a vehicle user interface, and, more specifically, a contextual vehicle user interface.

### BACKGROUND

Modern vehicles may include a user interface for use by a user of the vehicle to input instructions and/or modify settings of the vehicle. The user interface can take the form of one or more buttons or dials, and a display screen. Vehicle settings can include settings such as a car mode (e.g., sport mode, suspension settings, fuel consumption settings, etc.), audio settings, communication settings, map or directional settings, and many more.

While many of these settings may be changed while the vehicle is in park, the user may instead wish to change one or more settings while in motion. As such, a user's focus may be drawn away from the road and possible safety issues may arise.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for a contextual vehicle user interface. An example disclosed vehicle user interface includes a display for a plurality of menus, a steering wheel having a joystick, a gesture pad having a plurality of available input gestures, and a processor for modifying the display responsive to input from the steering wheel joystick and gesture pad. Further at least one input gesture is available for all displayed menus, and availability of at least one input gesture changes based on the menu displayed.

An example disclosed non-transitory, computer-readable medium comprises instructions that, when executed by a processor, cause a vehicle to perform a set of acts. The set of acts includes displaying a plurality of menus on a vehicle display. The set of acts also includes receiving input from a steering wheel joystick. The set of acts further includes receiving input via a gesture pad having a plurality of available input gestures. The set of acts further includes modifying the display responsive to the received input, wherein a first input gesture is available for all displayed menus and availability of a second input gesture changes based on the menu displayed.

Another example may include means for interacting with a vehicle via a vehicle user interface, including means for displaying a plurality of menus on a vehicle display, means for receiving input from a steering wheel joystick, means for receiving input via a gesture pad having a plurality of available input gestures, and means for modifying the display responsive to the received input, wherein a first input gesture is available for all displayed menus and availability of a second input gesture changes based on the menu displayed.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example perspective view of a contextual vehicle user interface inside a vehicle according to an embodiment of the present disclosure.

FIG. 2 illustrates an example block diagram of electronic components of the vehicle of FIG. 1.

FIGS. 3A-E illustrate example tactile gestures according to embodiments of the present disclosure.

FIGS. 4A-C illustrate example non-tactile gestures according to embodiments of the present disclosure.

FIG. 5 illustrates a flowchart of an example method according to embodiments of the present disclosure

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As noted above, modern vehicles may include a user interface for use by a user of the vehicle to input instructions and/or modify settings of the vehicle. In some vehicles, the user interface can take the form of a touch screen on a center portion of the front of the vehicle, such that a driver can view and interact with the touch screen. Many vehicle user interfaces are complex for a user to interact with, including many buttons and dials, and can include complex menus that are not intuitive to navigate. Further, many interfaces can require a high level of hand-eye coordination and/or focus for a user to operate, taking the user's attention away from the road. This is particularly apparent where the menu includes a long list of options that must be scrolled through.

Example embodiments herein provide an intuitive vehicle user interface that may enable a user of the vehicle to quickly and efficiently navigate and interact with various vehicle settings menus and options. The example vehicle user interfaces disclosed herein may provide design freedom to vehicle manufacturers by enabling the display screen to be placed forward in the vehicle, and/or out of reach of the user. Further, examples herein may provide simple, intuitive control of the vehicle, creating a positive experience for users of the vehicle. In particular, embodiments of the present disclosure may retain the full functionality of current systems, while providing a more intuitive, streamlined, and/or simplified control scheme.

In one embodiment, a vehicle user interface may include a display with a plurality of menus. The display may include a center screen of the vehicle, and the plurality of menus may include (i) a default menu, for which the time and temperature are displayed, (ii) an audio menu, for which a current song, next song, or other audio information is displayed, and (iii) a map menu, for which a map, directions, or other navigation based information is displayed.

The vehicle user interface may also include a joystick on a steering wheel of the vehicle. The joystick may be located at a position on the steering wheel near where a user's thumb is likely to be while holding the steering wheel. The joystick may be used for navigation of the menus and selection of one or more options.

The vehicle user interface may include a gesture pad configured to receive a plurality of available input gestures, which may be both touch and non-touch gestures. The gesture pad may be located on a center console near a shifter of the vehicle, such that it is easy for a user to reach. The gesture pad may be generally rectangular in shape, and may be configured to detect a plurality of gestures performed by one or more fingers, hands, styluses, or other input instruments. Some gestures may be available at all times regardless of a context of the menu displayed by the screen. But other gestures may only be available based on the context of the display. For instance, where the user interface is in a map context, the gesture pad may be configured to detect a two-finger pinch gesture, and may responsively zoom in or out of a displayed map. Other gestures are possible as well.

The vehicle user interface may also include a processor, configured to receive information from the joystick and/or gesture pad, and responsively modify the display.

### I. Example Vehicle User Interface

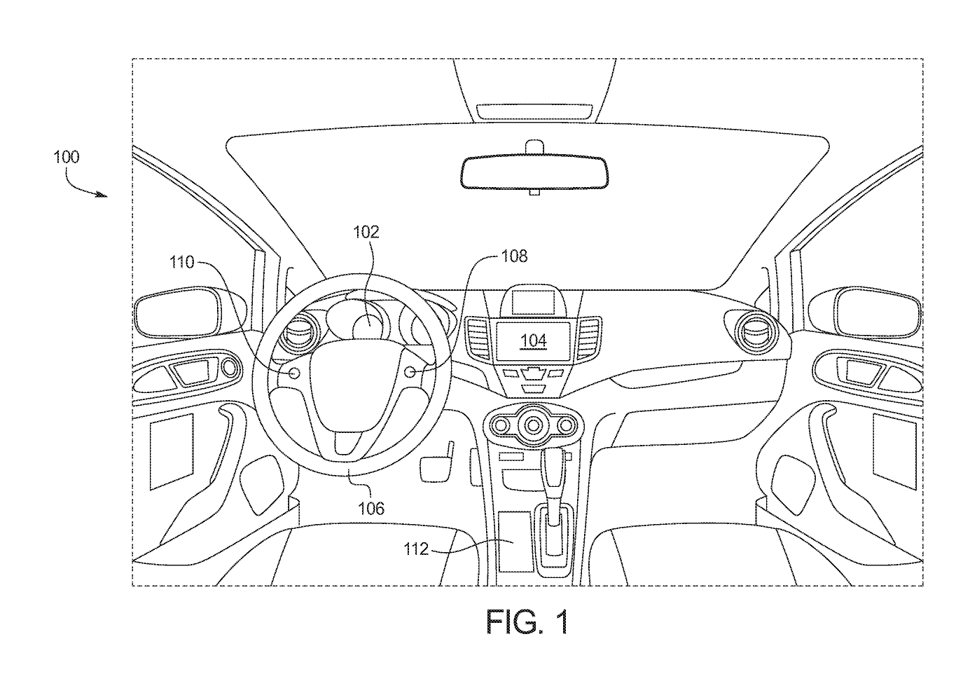

FIG. 1 illustrates an inside-vehicle perspective view of a vehicle user interface 100 according to embodiments of the present disclosure. The vehicle may be a standard gasoline powered vehicle, a hybrid vehicle, an electric vehicle, a fuel cell vehicle, and/or any other mobility implement type of vehicle. The vehicle may include parts related to mobility, such as a powertrain with an engine, a transmission, a suspension, a driveshaft, and/or wheels, etc. The vehicle may be non-autonomous, semi-autonomous (e.g., some routine motive functions controlled by the vehicle), or autonomous (e.g., motive functions are controlled by the vehicle without direct driver input).

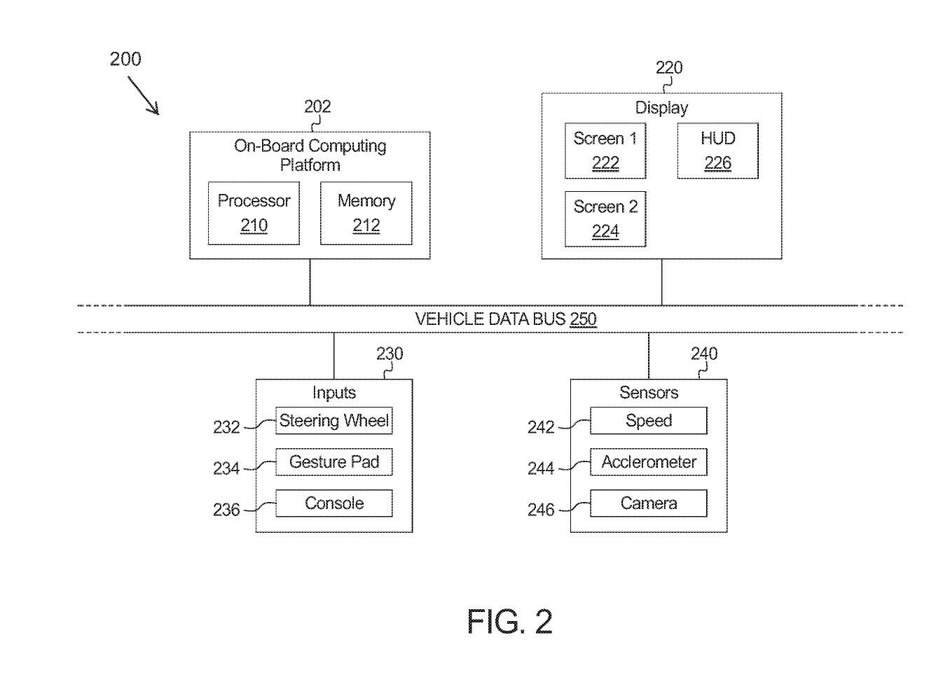

In the illustrated example, the vehicle user interface 100 may include a first screen 100, a second screen 104, a steering wheel 106, and a gesture pad 112. Vehicle 100 may also include one or more components described below with respect to FIG. 2.

The first screen 102 and second screen 104 may be configured to display information about the vehicle, the vehicle surroundings, maps, navigation information, audio information, communication information, etc. Each screen may be configured to display information independent from the other, such that one screen may provide vehicle data such as speed, direction, fuel usage, etc., while the other screen displays a currently playing song. In some examples, the vehicle may also include a heads-up display configured to display information to the user as well.

In some examples, vehicle user interface 100 may include two screens (102 and 104), while in other examples a different number of screens may be used. The screens may be located in the vehicle such that a driver of the vehicle has a clear view. For instance, the first screen 102 may be located directly in front of the driver in place of, or acting as, an instrument panel of the dashboard. Further, the second screen may be located in a central part of the dashboard or vehicle.

Screens 102 and 104 may be configured to display one or more menus, such as an audio menu, a map menu, and a default menu. Each menu may refer to a specific set of options, functions, and displayed icons. For instance, displaying the audio menu may include displaying a currently playing song, a next song, information about the audio settings of the vehicle (volume, equalization levels, etc.), and more. Displaying the map menu may include displaying a map, an address search box, navigation instructions, guidance options, and more. Further, displaying the default menu may include displaying current vehicle information (speed, heading, etc.), the time, date, weather information, and more. Other menus are possible as well, such as a phone menu in which contacts, current call time, call log, and other information are displayed.

Each menu may be associated with a particular context. For instance, the map menu may be associated with a map context, such that all navigation and map related options are available. Further, one or more gestures input via the gesture pad may be available only when the vehicle user interface 100 is in the map context. This is described in further detail below. Each context may group settings together in an intuitive manner. Further, when the vehicle user interface 100 is displaying a particular menu associated with a particular context, options, functions, settings, and input gestures not associated with that context may be unavailable to a user.

In some examples, screens 102 and 104 may both display information related to the same context, such as where screen 102 displays a current song playing and screen 104 displays volume settings for the current song. Or where screen 102 displays turn by turn navigation instructions while screen 104 displays a map showing all or part of the route.

In some examples, a user may control a first screen of screens 102 and 104, and the second screen may responsively change. This change may be automatic. For instance, a user may use a joystick or other input device to change screen 102 to a map menu, and screen 104 may responsively change, such that a map is displayed. The change to screen 104 may be automatic, and may not require any separate input by the user.

Alternatively, in some examples each screen may display different information (or information corresponding to different contexts). For instance, screen 102 may display general driving information (speed, rpm, engine temp, gas, etc.) while screen 104 may display audio information.

Vehicle user interface 100 may include a steering wheel 106, which have one or more joysticks 108 and 110. Steering wheel 106 may be connected to various other systems and electronic of the vehicle, and may have buttons or input devices for push to talk, vehicle control (cruise control, lights, etc.) and other control buttons.

Joysticks 108 and 110 may include one primary joystick and one secondary joystick. The primary joystick may be used for most or all decision making and selection by the user. Each joystick may be a two-axis joystick, allowing input of up, down, left, and right. Alternatively, the joysticks may include additional axis or measurement, such that more than four control directions may be used. For instance, each joystick may include a “click” functionality such that a user may press the joystick inward (as opposed to up, down, left, or right). This click function may act as a “select” or “ok” input. Further, each joystick may detect an angle of movement of joystick (e.g., pushed all the way right, or only 50% to the right) which may be used for some control of the vehicle user interface 100.

In some examples, control of vehicle user interface 100 may include commands by both joysticks simultaneously (i.e., both pushed down corresponds to one action, while one down one up corresponds to another, etc.).

In some examples, one or more menus may be organized in a tree and limb structure such that up and down input of the joystick scrolls through options/categories/folders of the structure, while right selects the current highlighted option and left reverts back to a previous screen. Other arrangements and organizations are possible as well.

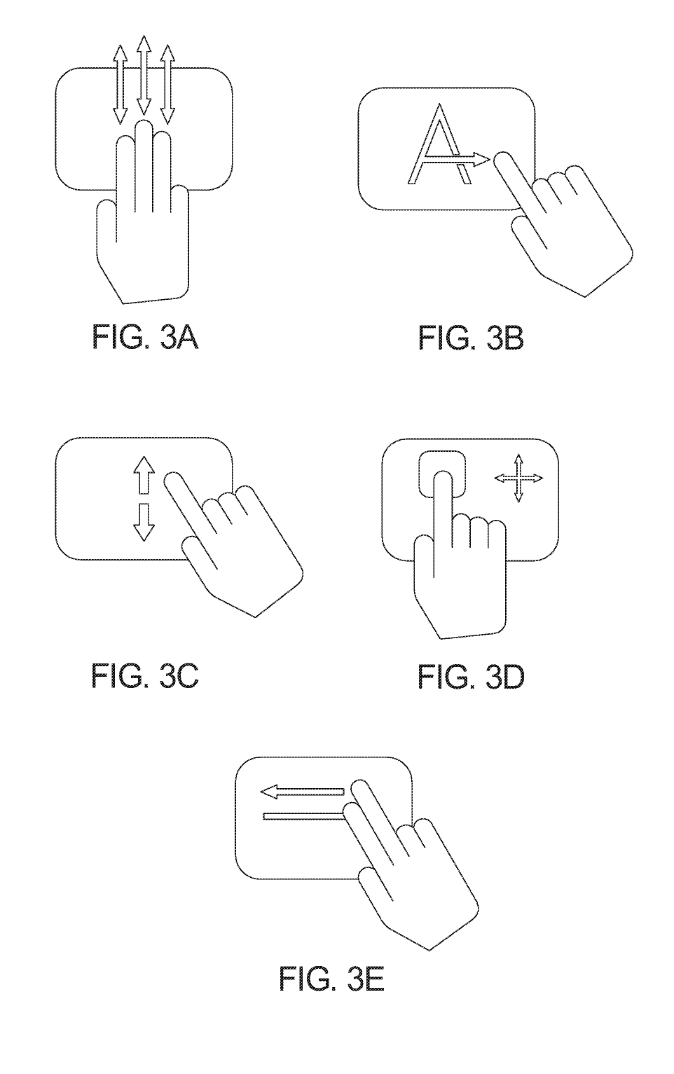

Vehicle user interface 100 may also include gesture pad 112. Gesture pad 112 may be positioned between the two front seats of the vehicle, on a center console. Other locations possible as well. Gesture pat 112 may be configured to receive tactile gestures and non-contact hand or object gestures, such as those described below with respect to FIGS. 3A-E and 4A-C.

The processor of vehicle user interface 100 (described below) may receive input from the gesture pad and joystick, and responsively modify the display on screens 102 and 104 based on detected gestures and joystick positions. In some examples, the processor and/.or gesture pad may be configured such that only a subset of gestures are available for control of the display at any given time. The availability of a particular gesture may depend on the current context of the screen, such as the current menu displayed.

When a gesture is termed “available”, it may signify that the gesture may be input to the gesture pad and an appropriate action may be taken based on the input gesture. Alternatively, when a gesture is termed “not available,” it may signify that the gesture cannot be input and cannot cause a corresponding action to be taken. For instance, the gesture pad may be configured to not recognize the particular gesture, to recognize it but not take any corresponding action, or to recognize all gestures and pass all gestures onto the processor, which may determine that the particular gesture is not available. In that case, an alert may be provided indicating that an unavailable gesture has been used, and the user must enter an available gesture only.

Contact or tactile gestures may include one-finger, two-finger, and three finger gestures. Non contact gestures may include hovering above the gesture pad for a threshold period of time (e.g., one second), and moving laterally up, down, left, or right. Other gestures are possible as well. Example contact and non-contact gestures are described below with respect to figured 3A-E and 4A-D.

In some examples, one or more gestures may be available at all times regardless of the context of the display screen. For instance, a three-finger swipe gesture may be available at all times, and may function to switch or scroll between displayed menus (e.g., from default to audio, audio to map, and map to default). In some examples, a preview may be displayed prior to switching, such that a user may determine whether to finish carrying out the menu switch action.

In other examples, one or more gestures may be available only for a particular context. For example, when the map menu is displayed, a two finger pinch gesture may be available. However, when the default or audio menus are displayed, the two finger pinch gesture may not be available.

Referring again to FIG. 1, vehicle user interface 100 may also include a processor, configured to receive input from the joysticks 108 and 110 and the gesture pad 112. And responsive to the received input, the processor may modify the display, including either of both of the first screen 102 and the second screen 104.

### II. Example Vehicle Electronics

FIG. 2 illustrates an example block diagram 200 showing the electronic components of an example vehicle, such as the vehicle of FIG. 1. As illustrated in FIG. 2, the electronic components 200 include an on-board computing platform 202, a display 220, an input module 230, and sensors 240, all in communication with each other via vehicle data bus 250.

The on-board computing platform 202 includes a microcontroller unit, controller or processor 210 and memory 212. The processor 210 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 212 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 212 includes multiple kinds of memory, particularly volatile memory and non-volatile memory.

The memory 212 may be computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 212, the computer readable medium, and/or within the processor 210 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The display 220 may include a first screen 222, a second screen 224, and a heads-up display (HUD) 226. Display 220 may also include one or more other components (not shown) including various lights, indicators, or other systems and devices configured to provide information to a user of the vehicle.

First screen 222 and second screen 224 may be any display suitable for use in a vehicle. For example, screens 222 and 224 may be liquid crystal displays (LCD), organic light emitting diode (OLED) displays, flat panel displays, solid state displays, any combination of these displays, or others. Further, first screen 222 and second screen 224 may be touch screens, non-touch screens, or may be partial touch screens in which a portion of the screen is a touch screen.

First screen 222 may be located in a front section of the vehicle, directly in front of a driver seat of the vehicle. Second screen 224 may be located in a center front area of the vehicle. Other placements of the first and second screens are possible as well.

In some examples, first screen 222 and second screen 224 may be configured to display complementary information. For instance, when a map menu is displayed, first screen 222 may display turn-by-turn instructions. Second screen 224 may display a map and/or compass. Alternatively, first screen 222 and second screen 224 may be configured to display non-complementary information, or to display information independent from each other. For instance, first screen 222 may display various dials and instruments (e.g., speedometer, odometers, etc.) while second screen 224 displays audio information.

HUD 226 may include a projector configured to project information such that it is visible to a user of the vehicle. For instance, HUD 226 may include a projector positioned in front of the driver's seat on the dashboard, such that information can be projected onto the front windshield of the vehicle. HUD 226 may be configured to display information that corresponds to information displayed on first screen 222 and/or second screen 224.

First screen 222, second screen, 224, and/or HUD 226 may share a processor with on-board computing platform 202. Processor 210 may be configured to display information on the screens and HUD, and/or modify the displayed information responsive to input received via one or more input sources.

Input module 230 may include a steering wheel 232, a gesture pad 234, and console buttons 236.

Steering wheel 232 may include one or more buttons, knobs, levers, or joysticks (such as joysticks 108 and 110 described above) for receiving input from a user of the vehicle.

Gesture pad 234 may include touch and non-touch sensors configured to receive gestures from a user. In some examples, gesture pad 234 may be a rectangular object located in a central portion of the vehicle, near a gear shift.

Console buttons 236 may include one or more dedicated buttons, levers, or other input devices for use by a user. The console buttons may be located on a center console of the vehicle, for easy access by the user.

Sensors 240 may be arranged in and around the vehicle to monitor properties of the vehicle and/or an environment in which the vehicle is located. One or more of the sensors 240 may be mounted on the outside of vehicle to measure properties around an exterior of the vehicle. Additionally or alternatively, one or more of the sensors 240 may be mounted inside a cabin of the vehicle or in a body of the vehicle (e.g., an engine compartment, wheel wells, etc.) to measure properties in an interior of the vehicle. For example, the sensors 240 may include a vehicle speed sensor 242, an accelerometer 244, and/or a camera 246.

Vehicle speed sensor 242 may include a sensor configured to detect a number of revolutions per time period (i.e., revolutions per minute). This value may correspond to the speed of vehicle, which may be determined, for instance, by multiplying the rate of wheel revolutions by the circumference of the wheel. In some embodiments, vehicle speed sensor 242 is mounted on the vehicle. Vehicle speed sensor 242 may directly detect a speed of the vehicle, or may indirectly detect the speed (e.g., by detecting a number of wheel revolutions).

Accelerometer 244 may detect one or more forces acting on the vehicle, which may be used to determine a speed or other value associated with the vehicle. Other sensors may be used in addition to or instead of an accelerometer.

Camera 246 may capture one or more images of the inside or outside of the vehicle. The capture images may be used by one or more systems of the vehicle to carry out one or more actions.

Sensors 240 may also include odometers, tachometers, pitch and yaw sensors, wheel speed sensors, magnetometers, microphones, tire pressure sensors, biometric sensors and/or sensors of any other suitable type.

The vehicle data bus 250 may communicatively couple the various modules, systems, and components described with respect to FIGS. 1 and 2. In some examples, the vehicle data bus 250 may includes one or more data buses. The vehicle data bus 250 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

### III. Example Gestures

FIGS. 3A-E and 4A-C illustrate example tactile and non-tactile gestures respectively, according to embodiments of the present disclosure. Gestures may be received by and interpreted by the gesture pad, in combination with a processor, to cause one or more changes to occur with respect to the vehicle.

Tactile gestures may be received by the gesture pad by recognizing one or more points of contact on the gesture pad, in addition to movement of the points of contact. Non-tactile gestures may be received by the gesture pad by recognizing an object hovering above the gesture pad, in addition to recognizing movement of the object. As such, the gesture pad may include one or more capacitive, resistive, acoustic, infrared, or other sensors type configured to detect the presence of an object.

FIG. 3A, for example, shows a three-finger tactile gesture in which a user swipes three fingers in a forward or backward motion. The gesture pad may recognize this gesture as indicating a request to change the menu displayed on the vehicle screen(s). For instance, this three-finger swipe gesture may cause the display to switch, scroll, or otherwise change between available menus, including the three menus described above (default, audio, and map). In some examples, simply touching three fingers on the touch pad may cause a preview to be displayed, wherein the preview indicates that an upward swipe will change to a first menu, and a downward swipe will change to a second menu. The user may then be confident that completing the three-finger swipe gesture either forward or backward will cause the intended menu to be displayed.

FIG. 3B illustrates an example one-finger transcription gesture. The one-finger transcription gesture may be a writing gesture performed such that an input movement is converted into a letter, number, or other text. This gesture may be useful, for example, when entering an address into a search bar of the map menu, searching for a song in the audio menu, or otherwise entering text. The one-finger transcription gesture may be available regardless of a context of the menu displayed.

FIG. 3C illustrates a two finger pinch gesture. The two-finger pinch gesture may be available based on the context of the display being a map menu, and may cause the display to zoom in or out of the map.

FIG. 3D illustrates a one finger pan gesture, which may include touching the gesture pad in a first location, and moving to a second location while remaining in contact with the gesture pad. The one-finger pan gesture may be available based on the context of the display being a map menu.

FIG. 3E illustrates a two finger swipe gesture. This gesture may be available based on the context of the display being an audio menu, and may include a side to side swipe of two fingers. When the audio menu is displayed, the two-finger swipe gesture may cause the vehicle user interface to switch to a next or previous song, or a next or previous radio station, or other audio source.

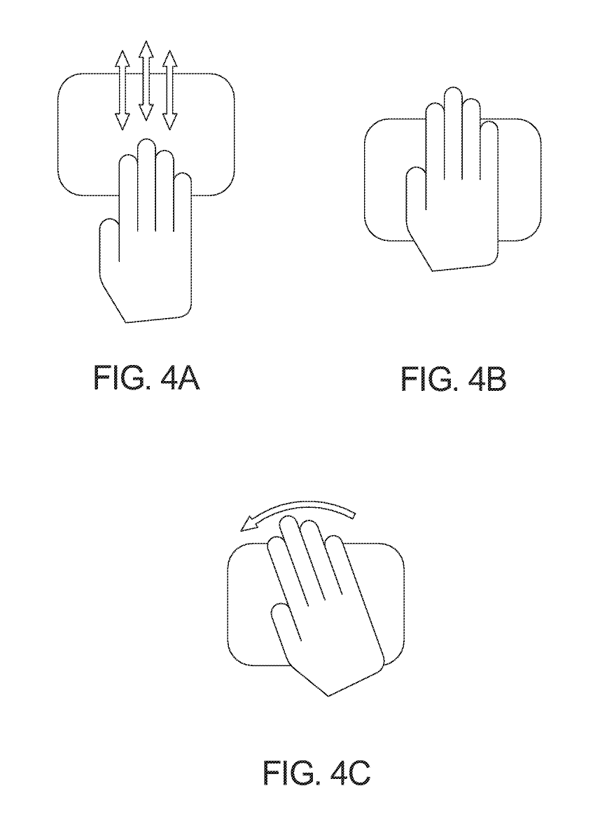

FIG. 4A illustrates a non-tactile gesture in which an object above the gesture pad is swiped up or down. This gesture may have similar or identical results to the tactile three-finger swipe gesture discussed above with respect to FIG. 3A.

FIG. 4B illustrates a hover gesture. The hover gesture may include a stationary object above the gesture pad for a threshold period of time (e.g., 1 second). In response to receiving this gesture, the display may preview a previous or next song or radio station. This gesture may be available based on the context of the displaying being an audio menu.

FIG. 4C illustrates a non-tactile side swipe motion. An object may be placed above the gesture pad, and then swiped toward one side or the other. In response to receiving this gesture, the display may switch to a next song or previous song.

Other tactile and non-tactile gestures are possible as well.

In some examples, one or more of the gestures described above may be a global gesture, such that the gesture is always available regardless of the context in which it is used. For example, global gestures may include the three-finger swipe gesture (FIG. 3A), the one-finger transcription gesture (FIG. 3B), and the non-tactile swipe up and swipe down gesture (FIG. 4A).

In addition, one or more gestures may only be available depending on a context of the displayed menu. For example, where the menu is a map menu, the two finger pinch gesture (FIG. 3C) may be available. However when the audio menu is active instead of the map menu, the two-finger pinch gesture may no longer be available.

### IV. Example Method

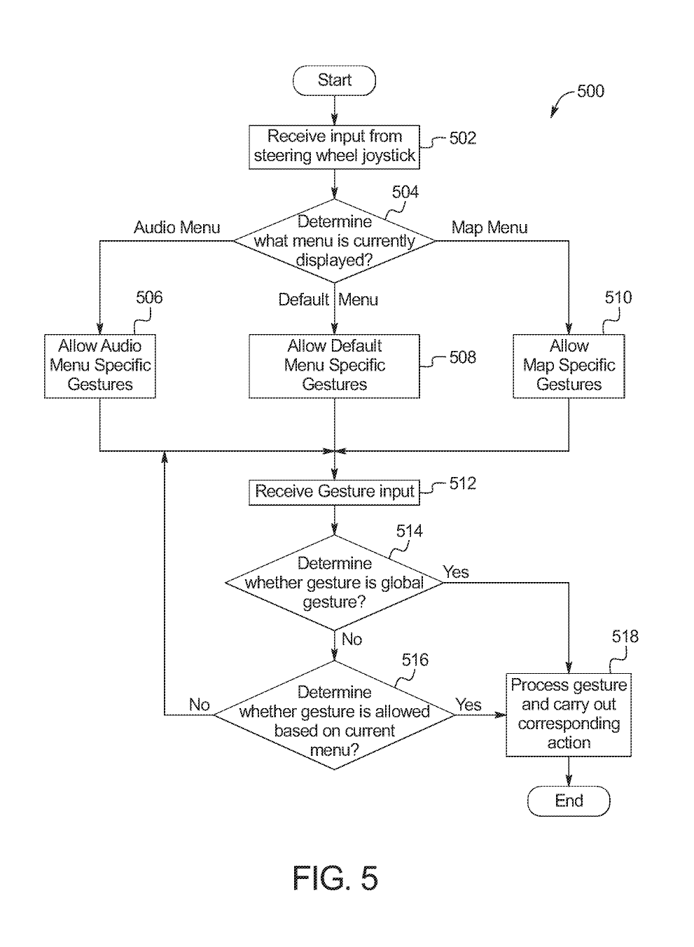

FIG. 5 illustrates an example method 500 according to embodiments of the present disclosure. Method 500 may provide a vehicle user interface making use of the components described herein. The flowchart of FIG. 5 is representative of machine readable instructions that are stored in memory (such as memory 212) and may include one or more programs which, when executed by a processor (such as processor 210) may cause a vehicle to carry out one or more functions described herein. While the example program is described with reference to the flowchart illustrated in FIG. 5, many other methods for carrying out the functions described herein may alternatively be used. For example, the order of execution of the blocks may be rearranged, blocks may be changed, eliminated, and/or combined to perform method 500. Further, because method 500 is disclosed in connection with the components, systems, and gestures of FIGS. 1-4, some functions of those components will not be described in detail below.

Initially, at block 502, method 500 includes receiving input from a steering wheel joystick. At block 504, method 500 may include determining what menu is currently displayed. This block may further include determining a context associated with the currently displayed menu. The resulting menu and context may determine which gestures are available for input.

If at block 504 it is determined that the current menu is an audio menu, block 506 of method 500 includes enabling audio menu specific gestures to be available. If at block 504 it is determined that the current menu is a default menu, block 508 of method 500 includes enabling default menu specific gestures to be available. And if at block 504 it is determined that the current menu is a map menu, block 510 of method 500 includes enabling map menu specific gestures to be available.

At block 512, method 500 includes receiving an input via the gesture pad. The received input may be an available gesture or an unavailable gesture, as described above. Then, at block 514, method 500 may determine whether the input gesture is a global gesture (e.g., the three-finger swipe or one-finger transcription gestures). If the input gesture is a global gesture, then method 500 may include block 518—processing the gesture and executing or carrying out the corresponding action.

However if the input gesture is not a global gesture, block 516 may include determining whether the input gesture is allowed based on the current menu. This may include, for example, comparing the input gesture to a database of available gestures. If the gesture is not allowed or not available, method 500 may include reverting back to block 512 in which a new gesture is input to the gesture pad. But if the input gesture is available, block 518 of method 500 may include processing the input gesture and carrying out the corresponding action.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A vehicle comprising:
a display for a plurality of menus;
a steering wheel having a joystick;
a gesture pad to receive a plurality of input gestures; and
a processor for modifying the display responsive to input from the steering wheel joystick and gesture pad,
wherein at least one input gesture provides a same action for all of the plurality of menus, and availability of at least one input gesture changes based on the menu displayed.

2. The vehicle of claim 1, wherein the plurality of menus comprises a map menu, an audio menu, and a default menu.

3. The vehicle of claim 1, wherein the at least one input gesture providing the same action comprises a three-finger swipe gesture, wherein the processor changes the menu displayed responsive to receiving the three-finger swipe gesture from the gesture pad.

4. The vehicle of claim 1, wherein the at least one input gesture providing the same action comprises a one-finger transcription gesture, wherein the processor displays text transcribed from the input gesture responsive to receiving the one finger transcription gesture input.

5. The vehicle of claim 1, wherein the plurality of gestures comprises a two-finger pinch gesture available when a map menu is displayed, such that the processor modifies the display by zooming in on a displayed map responsive to receiving the two-finger pinch gesture as input.

6. The vehicle of claim 1, wherein the plurality of gestures comprises a one-finger pan gesture available when a map menu is displayed, such that the processor modifies the display by panning a displayed map responsive to receiving the one-finger pan gesture.

7. The vehicle of claim 1, wherein the plurality of gestures comprises a two-finger swipe gesture available when an audio menu is displayed, such that the processor modifies the display by switching a displayed song title responsive to receiving the two-finger swipe gesture as input.

8. The vehicle of claim 1, wherein the display comprises a first screen located in front of a driver of the vehicle, and a second screen located in a center of the vehicle.

9. The vehicle of claim 8, wherein the processor is further for modifying the display of the second screen responsive to receiving the at least one input gesture providing the same action, while the first screen remains unchanged.

10. The vehicle of claim 1, wherein the gesture pad is located on a center console between two front seats of the vehicle.

11. The vehicle of claim 1, wherein an input of one or more of the plurality of input gestures causes the processor to perform an action that cannot be performed via control by the joystick of the steering wheel.

12. The vehicle of claim 1, wherein one or more of the plurality of input gestures comprise non-touch gestures input via the gesture pad.

13. A non-transitory, computer-readable medium, comprising instructions that, when executed, cause a vehicle to:
display a plurality of menus on a vehicle display;
receive input from a steering wheel joystick;
receive a plurality of input gestures via a gesture pad; and
modify the display in response to the input and the plurality of input gestures,
wherein a first input gesture provides a same action for all of the plurality of menus and availability of a second input gesture changes based on the menu displayed.

14. The non-transitory, computer-readable medium of claim 13, wherein the first input gesture comprises a three-finger swipe gesture, wherein modifying the display responsive to the received input comprises changing the menu displayed responsive to receiving the three-finger swipe gesture from the gesture pad.

15. The non-transitory, computer-readable medium of claim 13, wherein the first input gesture comprises a one-finger transcription gesture, wherein modifying the display responsive to the received input comprises displaying text transcribed from the input gesture responsive to receiving the one finger transcription gesture input.

16. The non-transitory, computer-readable medium of claim 13, wherein the vehicle display comprises a first screen located in front of a driver of the vehicle, and a second screen located in a center of the vehicle.

17. The non-transitory, computer-readable medium of claim 16, wherein the instructions further cause the vehicle to modify the display of the second screen responsive to receiving the first input, while the first screen remains unchanged.

18. The non-transitory, computer-readable medium of claim 13, wherein the gesture pad is located on a center console between two front seats of the vehicle.

19. The non-transitory, computer-readable medium of claim 13, wherein an input of one or more of the plurality of input gestures causes the processor to perform an action that cannot be performed via control by the joystick of the steering wheel.

20. The non-transitory, computer-readable medium of claim 13, wherein one or more of the plurality of input gestures comprise non-touch gestures input via the gesture pad.
